(19) United States
(12) Patent Application Publication
(10) Pub. No.: US 2024/0208819 A1
(43) Pub. Date: Jun. 27, 2024

(54) Exhaust Gas Systems and Methods

(71) Applicant: Electronic Fluorocarbons, LLC, Hopkinton, MA (US)

(72) Inventors: Kenneth G. Unfried, Redding, CT (US); Pavel Perlov, Hopkinton, MA (US); Matthew R. Adams, Newtown, PA (US); Thomas Arndt, Macungie, PA (US); Adam J. Seymour, Northglenn, CO (US)

(21) Appl. No.: 18/391,504

(22) Filed: Dec. 20, 2023

Related U.S. Application Data
(60) Provisional application No. 63/435,535, filed on Dec. 27, 2022.

(51) Int. Cl. C01B 23/00

(52) U.S. Cl. CPC C01B 23/0057; C01B 23/0042; C01B 2210/0032

(57) ABSTRACT

Systems for recovering neon from used neon are provided. The systems can include a pretreatment component operatively coupled to receive used neon gas from a system for producing UV light using neon, and a capture component operatively coupled to the pretreatment component. Methods for recovering neon from used neon are also provided.

### CROSS REFERENCE TO RELATED APPLICATION

This application claims priority to and the benefit of U.S. Provisional Patent Application Ser. No. 63/435,535 filed Dec. 27, 2022, entitled “Laser Exhaust Gas Systems and Processing”, the entirety of which is incorporated by reference herein.

### TECHNICAL FIELD

The present disclosure relates to exhaust gas systems and methods. In some embodiments, the present disclosure provides systems and methods for recovering and/or purifying neon from used neon. The used neon can be generated from laser exhaust gas.

### BACKGROUND

Neon is used in industrial processes including for producing UV light used in excimer lasers used in semiconductor manufacturing. Neon is a rare gas subject to supply chain disruptions, as much is produced in parts of the world subject to conflict. The neon is not consumed in the process and is normally exhausted to the atmosphere. The invention described here is a process to capture and process the neon for reuse.

### SUMMARY

Systems for recovering neon from used neon are provided. The systems can include: a pretreatment component operatively coupled to receive used neon gas from a system for producing UV light using neon; and a capture component operatively coupled to the pretreatment component. Methods for recovering neon from used neon are also provided. The methods can include: pretreating used neon gas received from a system for producing UV light using neon; capturing of the pretreated neon; and compressing of the captured neon.

Systems for recovering and purifying neon gas from used neon gas are additionally provided. The systems can include: a pretreatment component operatively coupled to receive used neon from a system for producing UV light using neon; and a purification component operatively engaged to receive neon released from the pretreatment component.

Methods for recovering and purifying neon from used neon gas are also provided. The methods can include: pretreating used neon gas after use to produce UV light; and purifying the pretreated neon.

### DRAWINGS

Embodiments of the disclosure are described below with reference to the following accompanying drawings.

FIG. 1 is a schematic of at least one embodiment of the systems and methods of the present disclosure.

FIG. 2 is a depiction of an example exhaust gas system and/or method according to an embodiment of the disclosure.

FIG. 3 is a depiction of an example exhaust gas system and/or method according to an embodiment of the disclosure.

### DESCRIPTION

This disclosure is submitted in furtherance of the constitutional purposes of the U.S. Patent Laws “to promote the progress of science and useful arts” (Article 1, Section 8).

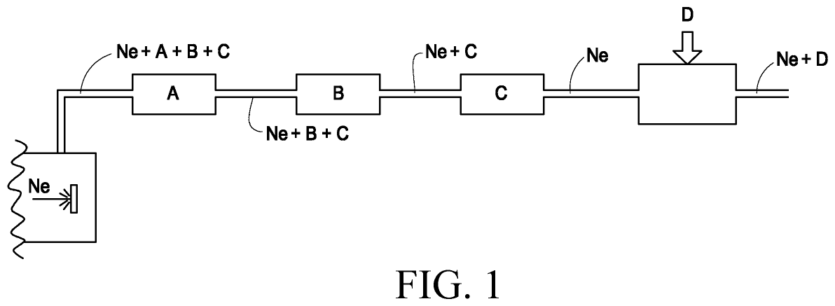

The present disclosure will be described with reference to FIGS. 1-3.

Referring to FIG. 1, a schematic of a system and/or method for recovering neon from used neon is shown. The systems and method can include a pretreatment component configured to remove at least some materials from used neon. Used neon can be neon that has been used during the production of UV light as a laser; for example, the used neon can be neon and other materials generated during use. Example materials that can be part of used neon are denoted as A, B, and C. Accordingly, used neon can include Ne+A+B+C.

In the pretreatment component of the system and/or method, A can be removed and at least Ne can be allowed to continue through the system and/or method. Included with the Ne can be B and C. A can be, for example, reactive fluorine. Accordingly, the pretreatment component can be operatively coupled to receive used neon gas from a system for producing UV light using neon. The pretreatment component houses an absorbent media comprising one or more of alumina, modified alumina, zeolite, transition metal hydride, transition metal getter, silica gel, and/or activated carbon, the absorbent media configured to retain used neon gas contaminants.

The system can include a pretreatment component operatively configured with one or more of a membrane, cryogenic separation, and/or pressure swing sorption, each of which can be configured to retain used neon gas contaminants.

The system can also include a capture component operatively coupled to the pretreatment component. The capture component can be configured to further purify used neon by allowing other materials to pass while Ne is retained. Some of the materials that pass are the B materials. When the Ne is released, it can include additional materials C. The capture component comprises a vacuum pump and/or a compressor. Accordingly, the pretreated neon can be captured by compressing at least the neon of the pretreated neon using a compressor and/or pump to provide a pressure differential to the pretreated neon.

The systems and/or methods can also include a purification component operatively engaged to receive neon released from the pretreatment component and/or from the purification component. Accordingly, Ne+C can be received by the purification component, C removed, and Ne released to further purify the Ne from the used neon.

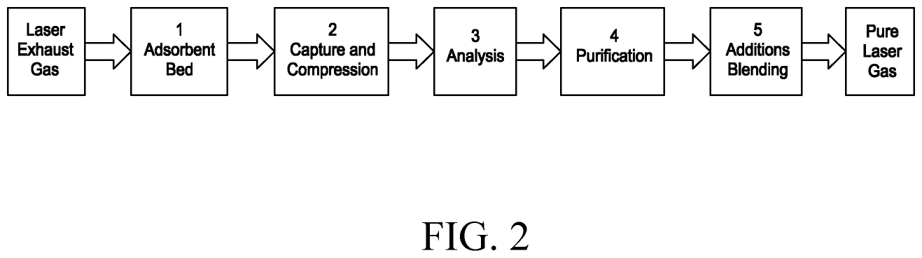

Referring to FIG. 2, the systems and methods can also include an analysis component operatively aligned between the pretreatment component and the purification component, the analysis component configured to determine impurity concentrations. The analysis component can be one or more of GC-PDHID (pulse discharged helium ionization detector), FTIR, CRDS (cavity ring down spectroscopy), and/or BGA (binary gas analyzer). Accordingly, the systems and/or methods can include capturing and/or compressing components operatively engaged between the pretreatment component and the analysis component.

In accordance with example implementations, methods for recovering and purifying neon from used neon gas are provided. The methods can include pretreating used neon gas after use to produce UV light and purifying the pretreated neon. The pretreating removes Fluorine from the used neon gas.

The purifying can include exposing the pretreated and/or captured neon gas to alumina, modified alumina, zeolite, transition metal hydride, transition metal getter, silica gel, and/or activated carbon using membrane, cryogenic separations and/or pressure swing sorption to remove the “C” materials such as HF, H₂O, CH₄, N₂, CO₂, CO, CF₄, SF₆, SiF₄, O₂, COF₂, NF₃, He, FNO₂, SO₂F₂, C₂F₆, and/or CHF₃.

In accordance with example implementations, after purifying, the purified neon gas can be blended with additional materials. The blending and/or removal of materials can be based on analysis of used neon performed within the system and/or during the method.

With reference to FIG. 2, the present disclosure provides systems and processes for recovering neon from, preferably, laser gas exhaust. The systems and process can include the steps of 1) pretreatment (adsorbent bed); 2) capture of the gas (capture and compression); 3) analysis of the gas; 4) purification of the gas; and 5) blending/addition of components.

The adsorbent bed can be configured to remove residual impurity components such as fluorine in laser exhaust gas. Additionally, initial purification to remove other impurity components can be conducted in this first step of the process using a sorbent bed or media that can include alumina, modified alumina, zeolite, transition metal hydride, transition metal getter, silica gel, and/or activated carbon using membrane, cryogenic separation, and/or pressure swing sorption. The low pressure and flow rate of this phase of the operation may result in better purification with some techniques.

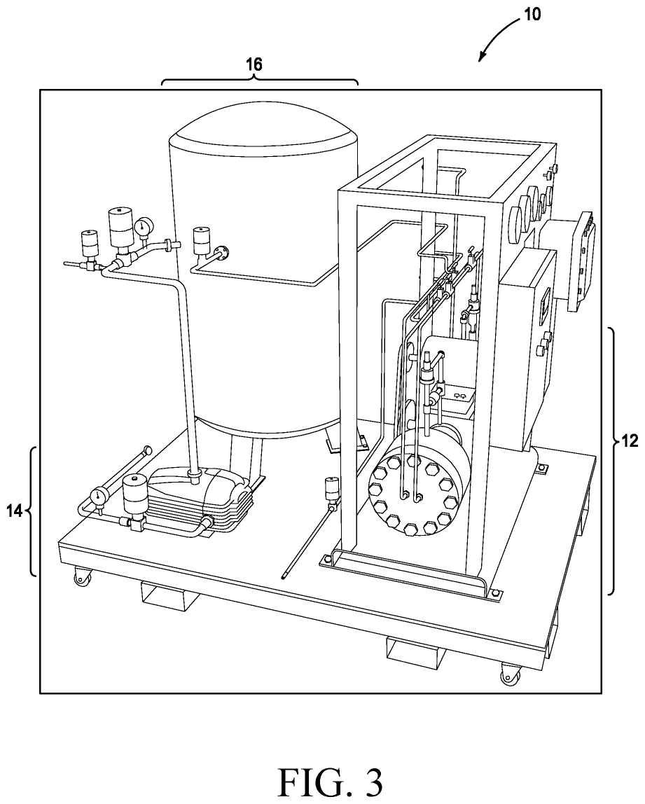

As shown in FIG. 3, a skid 10 with bellows pump compressor 12 in combination with vacuum pump 14 and buffer tank 16 can be configured to transfer treated laser gas into gas cylinders or other packages suitable for transportation, to allow transport to complete the process at another location.

Analysis of the compressed gas can be used to control the subsequent purification step. Techniques including GC-PDHID, FTIR, CRDS, BGA are used to determine impurity concentrations. The measured impurity concentrations determine the subsequent purification steps.

The purification step can include treatment of the recovered gas with alumina, modified alumina, zeolite, transition metal hydride, transition metal getter, silica gel, and/or activated carbon using membrane, cryogenic separations and/or pressure swing sorption to remove the HF, H₂O, CH₄, N₂, CO₂, CO, CF₄, SF₆, SiF₄, O₂, COF₂, NF₃, He, FNO₂, SO₂F₂, C₂F₆, CHF₃ present.

The additions (blending) step can add components to ensure that the final gas mixture is suitable for use as laser gas. At this point the laser-usable mixture can be filled into cylinders for transportation to the use location.

Accordingly, systems and/or processes for capture, purification and concentration adjustment are provided that can reuse excimer laser gases. In accordance with example implementations, the process can include: use of an adsorbent bed to remove reactive fluorine; capturing the gas using a vacuum pump and compressor; analysis of the captured laser gas to determine impurity concentration; purification to remove components that interfere with the laser operation; and addition of krypton, argon, xenon, and/or fluorine to make a bimix or trimix suitable for laser use.

The analysis can be in-line and may be conducted to monitor process operation, such as an oxygen analyzer to monitor the purity of the gas to be captured, for example.

The captured laser gas can be analyzed using GC-PDHID, FTIR, CRDS, BGA to determine impurity concentrations where those impurity concentrations determine the subsequent purification steps including alumina, modified alumina, zeolite, transition metal hydride, transition metal getter, silica gel, and/or activated carbon using membrane, cryogenic separations pressure swing sorption to remove impurities such as HF, H₂O, CH₄, N₂, CO₂, CO, CF₄, SF₆, SiF₄, O₂, COF₂, NF₃, He, FNO₂, SO₂F₂, C₂F₆, CHF₃.

The discharge pressure from the laser system can be between 1 and 70 psia.

The bimix or trimix are concentration adjusted using dynamic blending.

In accordance with example implementations, at least 90% of excimer laser gas effluent is captured and the yield of reusable mix is at least 90% of the captured quantities.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect.

1. A system for recovering neon from used neon, the system comprising:
a pretreatment component operatively coupled to receive used neon gas from a system for producing UV light using neon; and
a capture component operatively coupled to the pretreatment component.

2. The system of claim 1 wherein the pretreatment component houses an absorbent media comprising one or more of alumina, modified alumina, zeolite, transition metal hydride, transition metal getter, silica gel, and/or activated carbon, the absorbent media configured to retain used neon gas contaminants.

3. The system of claim 1 wherein the pretreatment component is operatively configured with one or more of a membrane, cryogenic separation, and/or pressure swing sorption, each of which is configured to retain used neon gas contaminants.

4. The system of claim 1 wherein the capture component comprises a vacuum pump and/or a compressor.

5. A method for recovering neon from used neon, the method comprising:
pretreating used neon gas received from a system for producing UV light using neon;
capturing of the pretreated neon; and
compressing of the captured neon.

6. The method of claim 5 further comprising, before pretreating, receiving laser gas from a UV light generator.

7. The method of claim 6 wherein the laser gas is discharged from at a pressure of between 1 and 70 psia.

8. The method of claim 6 wherein the pretreating removes reactive fluorine from the laser gas.

9. The method of claim 5 further comprising capturing the pretreated neon using a compressor and/or pump to provide a pressure differential to the pretreated neon.

10. The method of claim 5 further comprising compressing the captured neon using a compressor and/or pump.

11. A system for recovering and purifying neon gas from used neon gas, the system comprising:
a pretreatment component operatively coupled to receive used neon from a system for producing UV light using neon; and
a purification component operatively engaged to receive neon released from the pretreatment component.

12. The system of claim 11 further comprising an analysis component operatively aligned between the pretreatment component and the purification component, the analysis component configured to determine impurity concentrations.

13. The system of claim 12 wherein the analysis component is one or more of GC-PDHID (pulse discharged helium ionization detector), FTIR, CRDS (cavity ring down spectroscopy), and/or BGA (binary gas analyzer).

14. The system of claim 11 further comprising capturing and/or compressing components operatively engaged between the absorbent component and the analysis component.

15. The system of claim 11 wherein the purification component is configured to expose the neon retained on the absorbent component.

16. A method for recovering and purifying neon from used neon gas, the method comprising:
pretreating used neon gas after use to produce UV light; and
purifying the pretreated neon.

17. The method of claim 16 wherein the pretreating removes Fluorine from the used neon gas.

18. The method of claim 16 wherein the purifying comprises exposing the pretreated neon gas to alumina, modified alumina, zeolite, transition metal hydride, transition metal getter, silica gel, and/or activated carbon using membrane, cryogenic separations and/or pressure swing sorption to remove HF, H₂O, CH₄, N₂, CO₂, CO, CF₄, SF₆, SiF₄, O₂, COF₂, NF₃, He, FNO₂, SO₂F₂, C₂F₆, and/or CHF₃.

19. The method of claim 16 further comprising, after purifying, blending the purified neon gas with additional materials.

20. The method of claim 16 further comprising analyzing the pretreated neon gas to select a purification method and/or material.
